(19) United States
(12) Patent Application Publication
(10) Pub. No.: US 2015/0287561 A1
(43) Pub. Date: Oct. 8, 2015

(54) MAGNETIC ACTIVATION CIRCUIT FOR USE WITH CLOSURE MECHANISM

(71) Applicant: Annick Levesque, Montreal (CA)

(72) Inventor: Annick Levesque, Montreal (CA)

(21) Appl. No.: 14/436,730

(22) PCT Filed: Oct. 19, 2012
(86) PCT No.: PCT/CA2012/000974

§ 371 Date: Apr. 17, 2015

(51) Int. Cl. H01H 47/22; H02J 7/00; A44B 19/26; A45C 13/00; H05B 33/08; H01F 7/02; B65D 33/25; H01H 36/00; H05B 37/02

(52) U.S. Cl. CPC H01H 47/22; H01H 36/00; H02J 7/00; A44B 19/26; H05B 37/0209; H05B 33/0842; H01F 7/0273; B65D 33/25; A45C 13/00

(57) ABSTRACT

The present document describes activation circuits, having magnets mounted on a zipper slider, a magnetic switch, to detect the magnetic field from the magnet in proximity and activate an electronic circuit and a battery, to power the activation circuit. The present document also describes magnetic closure mechanism having the activation circuits, luggage including the closure mechanism, and a kit for installing the closure mechanism.

### BACKGROUND

(a) Field

The subject matter disclosed generally relates to an activation circuit. More specifically, the subject matter disclosed relates to an activation circuit including a zipper slider comprising a magnet, a magnetic switch, a battery, and an electrical element.

(b) Related Prior Art

Zippers are widely used to open and close an opening in a piece of fabric, bags, and/or to removably/reversibly couple two pieces of fabric together, or two sides of bag together.

Zippers may be used as switches to detect the open and closed state of an opening. For example, Japanese patent application No. JP2011184817A describes a magnetism activated devices providing an alarm when the zipper of a garment, such as a pant or a skirt, is left open. The switch is made of two parts, 1) the zipper slider and 2) part of an electronic circuit which activates an alarm held in a belt buckle. Accordingly, although the electronic circuit has two components 1) the switch part and 2) the alarm part, this device is comprised of two parts—the zipper slider and the circuit/alarm combo, and it does not make this device amenable to use in other context as the alarm is not separate and/or replaceable. Furthermore, the magnet used to provide the magnetism necessary for the device activation, is positioned such that the magnetic field projected is the weakest achievable, since it is perpendicular to the zipper axis.

Therefore, there is a need for a widely useable magnetic closure mechanism capable of activating or closing an electric circuit.

Furthermore, there is a need for an optimized magnetic closure mechanism capable of activating or closing an electric circuit.

### SUMMARY

According to an embodiment, there is provided an activation circuit comprising:
a zipper slider, configured to open and close a zipper by moving along a zipper axis, the zipper slider comprising a magnet from which emanates a magnetic field;
a magnetic switch, configured to change state upon detection of a magnetic field from the magnet in proximity to the magnetic switch;
a battery, electrically coupled to the magnetic switch to power on or off the activation circuit;
   wherein the magnetic switch and the zipper slider may be configured so that the magnetic field that emanates from the magnet activates or deactivates the magnetic switch when the zipper slider is in proximity of the magnetic switch, and wherein the magnet is configured upon the zipper slider to emanate a strongest magnetic field from a strongest position, for optimal detection by the magnetic switch.

According to another embodiment, there is provided an activation circuit comprising:
a magnet from which emanates a magnetic field, the magnet being configured to be mounted on a zipper slider, the zipper slider configured to open and close a zipper by moving along a zipper axis;
a magnetic switch, configured to detect a magnetic field from the magnet in proximity to the magnetic switch;
a battery, electrically coupled to the magnetic switch to power on or off the activation circuit;
   wherein the magnetic switch and the zipper slider may be configured so that the magnetic field that emanates from the magnet activates or deactivates the magnetic switch when the zipper slider moves on the zipper, and wherein the magnet may be configured upon the zipper slider to project a strongest magnetic field from a strongest position, for optimal detection by the magnetic switch.

The activation circuit may further comprise a manual toggle switch, electrically coupled to the activation circuit and configured to activate or inactivate the activation circuit.

The activation circuit may be further comprising a timer configured to inactivate the activation circuit after a predetermined time elapsed.

The magnet comprises a north pole and a south pole.

The magnetic field may be strongest from the north pole.

The magnetic switch may be configured to detect the magnetic field projected from the magnet from the strongest position.

The activation circuit may be further comprising an electrical element, electrically coupled to the magnetic switch.

The magnet may be mounted on the zipper slider.

The magnet may be removably mounted on the zipper slider.

The zipper slider further comprises a magnet mounting portion.

The magnet mounting portion may be configured to prevent interference from an object surrounding the magnet mounting portion during movement of the zipper slider along the zipper axis.

The magnet mounting portion may be rounded.

The zipper slider further comprises a zipper pull.

The electrical element may be chosen from a light source, an sound emitting device, a vibrating device, and a wireless communication device.

The light source may be a light emitting diode (LED) circuit, an incandescent light emitting circuit, or a combination thereof.

The light source may be configured to illuminate downwardly.

The sound emitting device may be an alarm device.

The battery may be chosen from a small button cell, a rechargeable battery, a solar cell, and combinations thereof.

The electrical power may be wireless inductive power.

The battery may be mounted to the electrical element.

The electrical element further comprises a securing portion, to secure the electrical element in a fixed position.

The zipper slider may be configured to activate the activation circuit when in proximity to the magnetic switch.

The zipper slider may be configured to deactivate the activation circuit when in proximity to the magnetic switch.

The activation circuit may be activated or deactivated when the zipper slider is near the fully open position of the zipper.

The activation circuit may be activated or deactivated when the zipper slider is near the fully closed position of the zipper.

According to another embodiment, there may be provided a magnetic closure mechanism comprising
a zipper tape having a first and second parallel zipper strip,
a zipper coupled to the zipper tape, the zipper comprising a first and second set of zipper teeth, and
an activation circuit of the present invention.

The magnet may be configured upon the zipper slider to project the strongest magnetic field along the zipper axis.

The magnet may be configured upon the zipper slider to project the strongest magnetic field perpendicular to the zipper axis.

According to another embodiment, there is provided a luggage comprising a magnetic closure mechanism of the present invention.

The luggage may be chosen from a chest, a trunk, a suitcase, a duffel bag, a carpet bag, a handbag, a backpack, and a shoulder bag.

According to another embodiment, there is provided a kit for the installation of a magnetic closure mechanism comprising
a magnetic closure mechanism of the present invention; and
a hole punch configured to punch at least one hole in a material to secure the electrical element in position.

The hole punch may be a leather punch.

The following terms are defined below.

The term “strongest magnetic field” or “strongest position” is intended to mean that the position of the magnet is such that the magnetic field projected from its poles is the strongest. For bar, disc or round magnets, the magnetic field is the strongest from the north pole. According to the present invention, the orientation of the magnet (and the magnetic field) is so that the activation of the circuit is made by the strongest magnetic field.

The term “emanate” is intended to mean to issue or spread out from, to originate from, be produced by, propagates, or projects from (a source). As used herein, the term is used to express that the magnetic field comes from the magnet.

The term “activate” or “activating” is intended to mean turning on the activation circuit or electrical element, and closing the circuit.

The term “deactivate” or “deactivating” is intended to mean turning off the activation circuit or electrical element, and opening the circuit.

The term “changing state” is intended to mean changing from a first state (e.g. on, closed) to second state (e.g. off, open).

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIGS. 1A-B illustrate zipper elements according to embodiments of the present invention;

FIGS. 2A-G illustrate a zipper slider according to an embodiment of the present invention;

FIG. 3 illustrates an activation circuit according to an embodiment of the present invention;

FIGS. 4A-B illustrate a hole punch according to an embodiment of the present invention;

FIGS. 5A-C illustrate (A) a top perspective, (B) bottom perspective, and (C) side view of an electrical element according to an embodiment of the present invention.

It will be noted that throughout the appended drawings, like features are identified by like reference numerals.

### DETAILED DESCRIPTION

In a first embodiment there is disclosed an activation circuit. The circuit comprises
a zipper slider, configured to open and close a zipper by moving along a zipper axis, the zipper slider comprising a magnet from which emanates a magnetic field;
a magnetic switch, configured to change state upon detection of a magnetic field from the magnet in proximity to the magnetic switch;
a battery, electrically coupled to the magnetic switch to power on or off the activation circuit;
wherein the magnetic switch and the zipper slider are configured so that the magnetic field that emanates from the magnet activates or deactivates the magnetic switch when the zipper slider is in proximity of the magnetic switch, and wherein the magnet is configured upon the zipper slider to emanate a strongest magnetic field from a strongest position, for optimal detection by the magnetic switch.

In a second embodiment there is disclosed a magnetic closure mechanism comprising
a zipper tape having a first and second parallel zipper strip,
a zipper coupled to the zipper tape, and comprising a first and second set of zipper teeth,
a activation circuit of the present invention.

In a third embodiment there is disclosed a luggage comprising a magnetic closure mechanism of the present invention.

In a fourth embodiment there is disclosed a kit for the installation of a magnetic closure mechanism of the present invention.

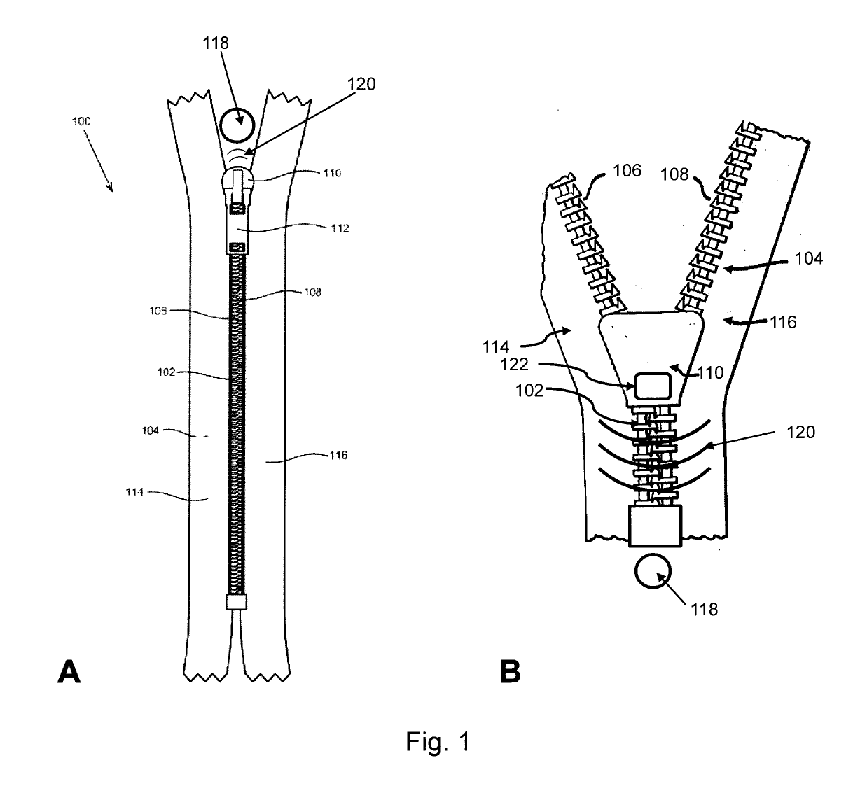

According to the first embodiment, there is disclosed an activation circuit for activating a magnetically responsive electronic circuit. Now referring to FIGS. 1A-B and 2A-G, the zipper slider (110, 210) is configured to open and close a zipper (102) by moving along a zipper axis, and comprises at least one magnet (122, 222) from which emanates a magnetic field (120). According to another embodiment, the activation circuit may comprise at least one magnet (122, 222) configured to be mounted on a zipper slider (110, 210), which may be used to modify existing zipper sliders. The magnet (122, 222) may be any suitable magnet, such as bar, disc, or bead magnets. According to an embodiment, the magnet has an orientation where the emanating magnetic field is strongest. For example, the magnet may have a north pole and a south pole and emanates a magnetic field (120) that is the strongest from the north pole. The activation circuit also includes a magnetic switch (118), which is configured to change state upon detection of a magnetic field (120) from the magnet in proximity to the magnetic switch (118). The magnetic switch (118) functions as a magnetic field detector. As used herein, change state is intended to mean that the magnetic switch (118) may change from an off state to an on state, or vice versa. In other words, the magnetic switch (118) may be activated or deactivated by the magnetic field (120), closing or opening the activation circuit. The magnetic switch (118) and the zipper slider (110) are configured so that the magnetic field (120) that emanates from the magnet activates or deactivates the magnetic switch when the zipper slider (110) is in proximity of the magnetic switch (118). According to an embodiment, the zipper slider (110) may be configured to activate the activation circuit when in proximity to the magnetic switch (118). Alternatively, according to another embodiment, the zipper slider (110) may be configured to deactivate the activation circuit when in proximity to the magnetic switch (118). According to another embodiment, the activation circuit may be activated or deactivated when the zipper slider (110) is near the fully closed position of the zipper (102), such as in FIG. 1A. According to another embodiment, the activation circuit may be activated or deactivated when the zipper slider (110) is near the fully open position of said zipper (102), such as in FIG. 1B.

According to an embodiment, the magnet (122, 222) is configured upon the zipper slider (110) to emanate the strongest magnetic field (120) from a strongest position (e.g. from the north pole), for optimal detection by the magnetic switch (118) and activation of the activation circuit. By activation and deactivation, it is meant that the electronic circuit may be either turned “on” or “off”, depending on the intended purpose of the activation circuit.

The optimal positioning of the magnet (122, 222) advantageously allows smaller magnets, weaker magnets, or a smaller number of magnets to be used in the switch of the present invention. This is particularly important when the circuit of the present invention is used in proximity to magnetically sensitive materials, such a credit cards (or any other magnetic strip containing cards) in a handbag.

According to an embodiment, the magnetic switch (118) is configured to detect the magnetic field which emanates from the magnet (122, 222) from the strongest position. Preferably, the magnetic switch (118) is positioned such that the magnetic field (120) is projected from the north pole of the magnet (122, 222).

According to another embodiment, the activation circuit of the present invention may also include a manual toggle switch, which may be, for example, a depressible button. It may be configured to activate or inactive the activation circuit of the present invention. This manual toggle may be useful in situations where the activation circuit needs to be turned on or off independently of the position of the magnet (222) on the zipper (102).

According to another embodiment, the activation circuit of the present invention may also include a timer configured to inactivate the activation circuit after a predetermined amount of time has elapsed. For example, the timer may turn the activation circuit off after 10, 20, 30, 40, 50 seconds, or after 1, 2, 3, 4, 5, 6, 7, 8, 9, or 10 minutes. This timer may be useful to generally restrict the time of activation of the activation circuit. This may be particularly useful in situations where the activation circuit is left open unattended and/or unintentionally. This feature could prevent complete draining of the battery powering the activation circuit of the present invention.

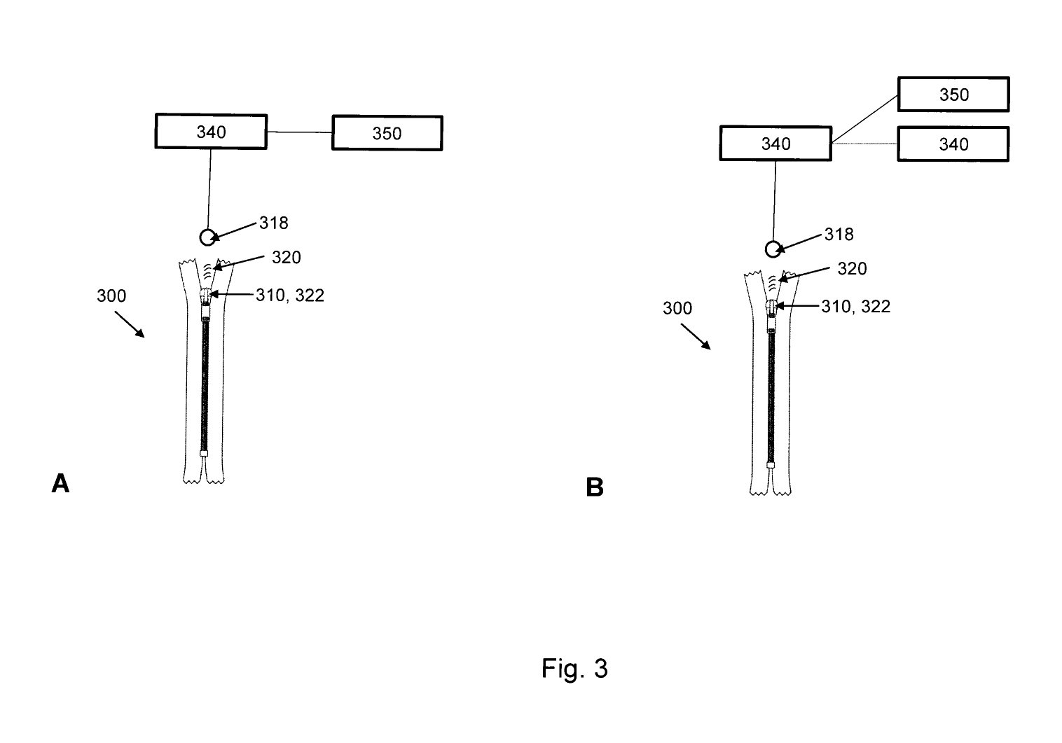

Now referring to FIGS. 3A-B, according to another embodiment, the activation circuit further includes a battery (350) electrically coupled to the magnetic switch (318), for example directly, through to an electrical element (340), or both, to power on or off the activation circuit. According to another embodiment, the battery (350) may be chosen from a small button cell, a rechargeable battery, a solar cell, and combinations thereof. According to another embodiment, the electrical power of the battery (350) may be supplied wirelessly to the electronic circuit. For example, by wireless inductive power transmission. According to another embodiment, the battery (350) may be directly mounted on the electrical element (340).

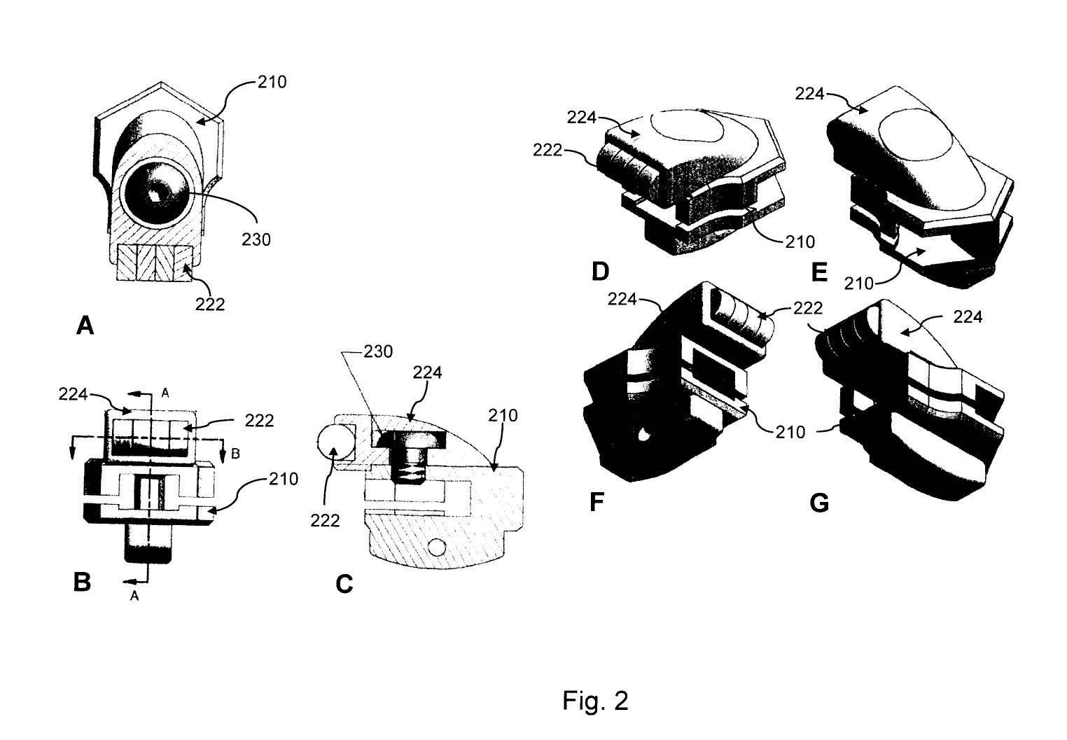

According to another embodiment, the magnet (222) may be removably mounted on the zipper slider (210). According to another embodiment, the zipper slider (210) may further have a magnet mounting portion (224), to receive and position the magnet (222) according to the invention. According to an embodiment, the magnet mounting portion (224) is configured to prevent interference from an object surrounding the magnet mounting portion (224) during movement of the zipper slider (210) along the first and second set of zipper teeth (106,108) along a zipper axis. According to a preferred embodiment, the magnet mounting portion (224) is rounded. According to an embodiment, as shown in FIG. 2, the magnet mounting portion (224) is located on the surface opposite to the surface of the zipper slider (210) having the zipper pull. According to this embodiment, the magnet mounting portion (224) may be secured to the zipper slider (210) by fastener (230) for example. According to another embodiment, the zipper slider (210) may comprise an integrally formed magnet mounting portion (224). In use, for example in a bag, the magnet mounting portion (224) would be located inside the bag.

According to another embodiment, the magnet (220) is configured upon the zipper slider (210) to emanate the strongest magnetic field along the zipper axis (that is, along the same direction of the zipper axis). According to another embodiment, the magnet (220) is configured upon the zipper slider (210) to project the strongest magnetic field perpendicular to the zipper axis (that is, at an angle 90 degrees to the zipper axis, which includes any of the possible perpendicular positions).

Also, according to another embodiment, the activation circuit may includes an electrical element (340), electrically coupled to the magnetic switch (318), to the battery (350), or both. According to another embodiment, the electrical element (340) can be chosen from light sources, sound emitting devices, vibrating devices, and a wireless communication device.

Non limiting examples of light sources include light emitting diodes (LED) circuit, incandescent light emitting circuits, or combinations thereof. According to a preferred embodiment, the light source is configured to illuminate downwardly. Non limiting examples of sound emitting devices include for example an alarm device, such as buzzers or whistles, or one or more small speakers.

According to an embodiment, wireless communication device may be used to communicate remotely the opening of the item having an activation circuit of the present invention. This information could be communicated wirelessly to a network accessible device such as a computer, a cellular phone or a smartphone. This may be useful also to communicate the remote location of such an item, when it has been stolen or lost. Examples of such wireless communication device may be a global positioning system (GPS) receiver and transmitter, and wireless communication microchips. Also, the information could be communicated to the owner of the item having the magnetic switch of the present invention, to an item worn by the owner, such as a small speaker mounted on clothing, or jewelry for example.

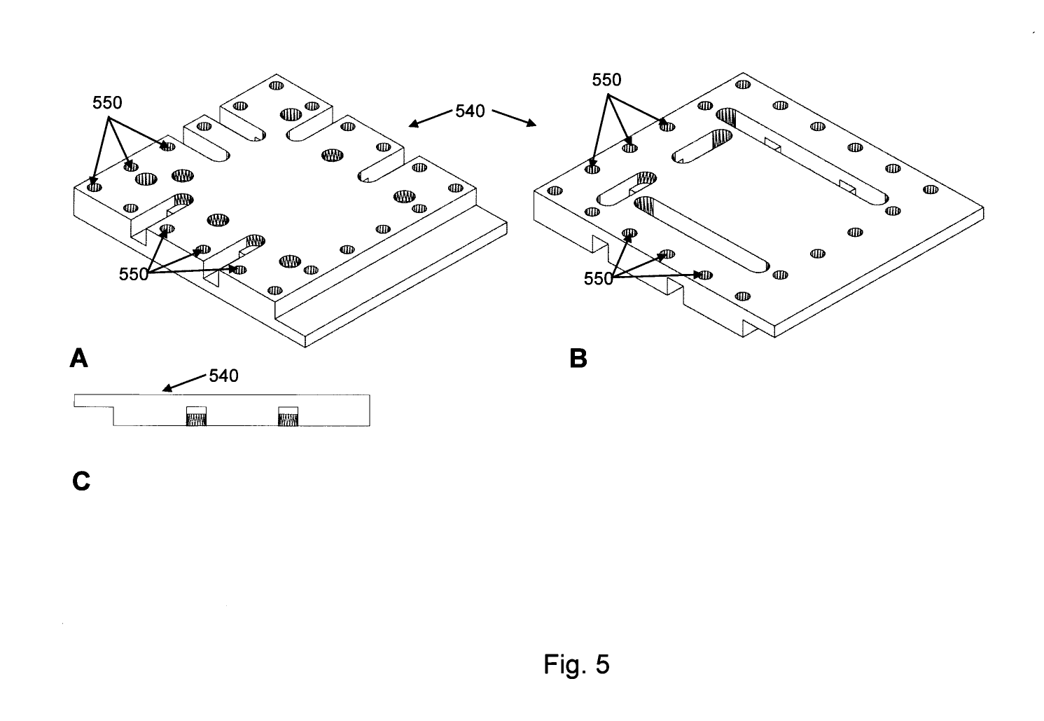

Now referring to FIGS. 5A to C, according to another embodiment, electrical element (540, a small circuit board) may also have a securing portion, to secure the electrical element in a fixed position. The securing portion is useful when the electrical element (540) is to be installed in a fixed position, to perform a specific function (e.g. lighting). The securing portion may comprise any suitable attachment means, such as holes (550) to receive threads, clips, hook and loop fastener, and the likes.

According to the second embodiment, there is provided a magnetic closure mechanism comprising
a zipper tape (104) having a first and second parallel zipper strip (114, 116),
a zipper (102) coupled to the zipper tape (104), comprising a first and second set of zipper teeth (106, 108), and
an activation circuit of the present invention.

Now referring to FIG. 1, the magnetic closure mechanism comprises a zipper element (100) having a zipper tape (104) having a first and second parallel zipper strip (114, 116), a zipper (102) coupled to the zipper tape (104), and including a first and second set of zipper teeth (106, 108). The zipper element (100) also includes a zipper slider (110), coupled to a zipper pull (112), which is configured to open and close the zipper by moving along the first and second set of zipper teeth along a zipper axis.

According to the third embodiment, there is provided a luggage comprising the magnetic closure mechanism of the present invention. Non limiting examples of luggage include chests, trunks, suitcases, duffel bags, carpet bags, handbags, backpacks, and shoulder bags. For example, according to an embodiment, the magnetic closure mechanism of the present invention may be used to provide lighting to the interior of such luggage. Upon opening of the zipper element (100), the magnet (222) is brought in close proximity to the magnetic switch (118), activating the detector to turn on LED light circuits (e.g. 340) inside the luggage. Alternatively, the magnetic closure mechanism of the present invention may be used in the reverse way, where upon closure of the zipper element (100), the magnet (222) is brought in close proximity to the magnetic switch (118), activating the detector to turn off LED light circuits (e.g. 340) inside the luggage.

The magnetic closure mechanism of the present invention may be installed anywhere a zipper can be used to active and or close a circuit in a useful manner. Another example includes installation in a tent, to automatically activate a light, or sound an alarm.

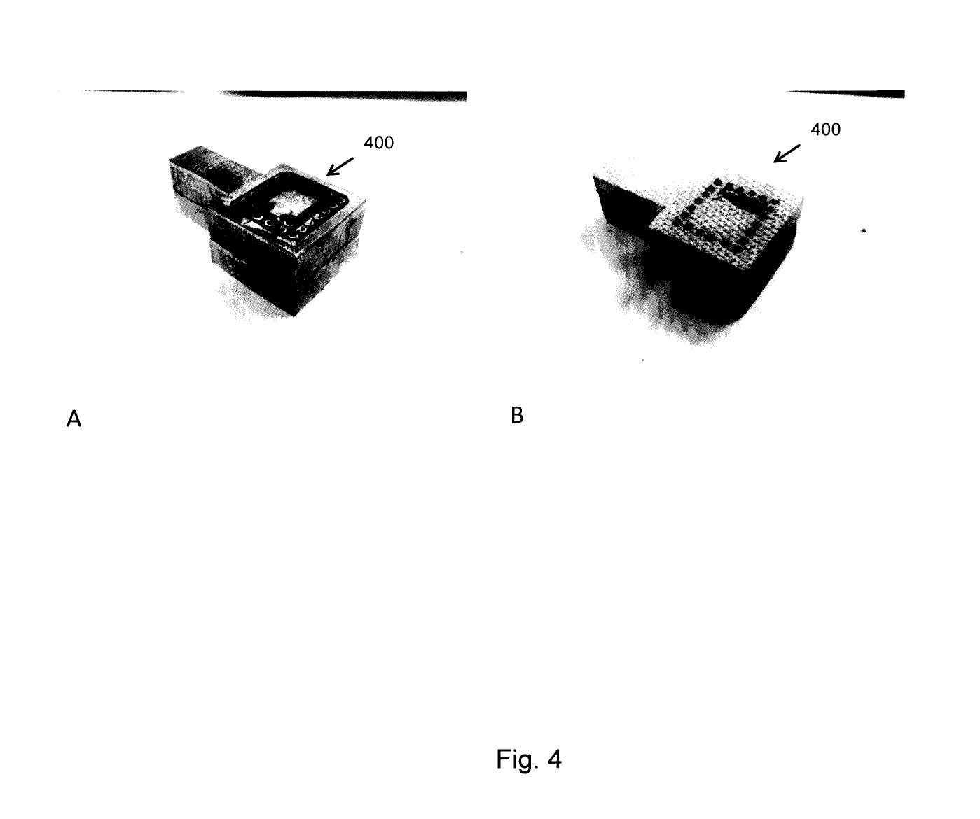

According to the fourth embodiment, there is provided a kit for the installation of a magnetic closure mechanism. The kit includes a magnetic closure mechanism of the present invention, and a hole punch configured to punch at least one hole in a material to secure the electrical element in position. The material may be any suitable material such as fabrics (cotton, wool, synthetic fibers, etc), or leathers and artificial leather, papers, plastics and metals. For example, the hole punch may be a leather punch (400) such as shown in FIG. 4.

The present invention will be more readily understood by referring to the following examples which are given to illustrate the invention rather than to limit its scope.

### EXAMPLE 1

### Handbag Lighting System

Now referring to FIG. 3B, where zipper element (300) having zipper slider (310) and magnet (322) disposed underneath the zipper slider (310) emanates a magnetic field (320) oriented along the zipper axis. The magnet (322) activates magnetic switch (318), which turns on a dual set of LED light (340) powered by two CR2032 3V batteries (350). The LED lights circuits (340) have a plurality of small holes disposed thereon (e.g. around the periphery of the circuit board, although location may vary according to need), and they are installed in a handbag by punching suitable holes with leather punch (400), in an interior surface of the handbag, which provides a plurality of small holes through which a thread can be sewn to fix them in place inside the handbag. The LED light circuits (400) are oriented such that the emitted light is directed toward the interior and bottom of the handbag, so as to illuminate its content.

While preferred embodiments have been described above and illustrated in the accompanying drawings, it will be evident to those skilled in the art that modifications may be made without departing from this disclosure. Such modifications are considered as possible variants comprised in the scope of the disclosure.

1. An activation circuit comprising:
a zipper slider, configured to open and close a zipper by moving along a zipper axis, said zipper slider comprising a magnet from which emanates a magnetic field;
a magnetic switch, configured to change state upon detection of a magnetic field from said magnet in proximity to said magnetic switch;
a battery, electrically coupled to said magnetic switch to power on or off said activation circuit;
wherein said magnetic switch and said zipper slider are configured so that the magnetic field that emanates from said magnet activates or deactivates said magnetic switch when said zipper slider is in proximity of said magnetic switch, and
wherein said magnet is configured upon said zipper slider to emanate a strongest magnetic field from a strongest position, for optimal detection by said magnetic switch.

2. An activation circuit comprising:
a magnet from which emanates a magnetic field, said magnet being configured to be mounted on a zipper slider, said zipper slider configured to open and close a zipper by moving along a zipper axis;
a magnetic switch, configured to detect a magnetic field from said magnet in proximity to said magnetic switch;
a battery, electrically coupled to said magnetic switch to power on or off said activation circuit;
wherein said magnetic switch and said zipper slider are configured so that the magnetic field that emanates from said magnet activates or deactivates said magnetic switch when said zipper slider moves on said zipper, and
wherein said magnet is configured upon said zipper slider to project a strongest magnetic field from a strongest position, for optimal detection by said magnetic switch.

3. The activation circuit of claim 1, further comprising a manual toggle switch, electrically coupled to said activation circuit and configured to activate or inactivate said activation circuit.

4. The activation circuit of claim 1, further comprising a timer configured to inactivate said activation circuit after a predetermined time elapsed.

5. The activation circuit of claim 1, wherein said magnet comprises a north pole and a south pole, and wherein optionally said magnetic field is strongest from said north pole.

6. (canceled)

7. The activation circuit of claim 1, wherein said magnetic switch is configured to detect said magnetic field projected from said magnet from said strongest position.

8. The activation circuit of claim 1, further comprising an electrical element, electrically coupled to said magnetic switch.

9. The activation circuit of claim 1, wherein said magnet is mounted on said zipper slider, and optionally said magnet is removably mounted on said zipper slider.

10. (canceled)

11. The activation circuit of claim 1, wherein said zipper slider further comprises a magnet mounting portion, and optionally said magnet mounting portion is configured to prevent interference from an object surrounding said magnet mounting portion during movement of said zipper slider along said zipper axis, and further optionally said magnet mounting portion is rounded.

12. (canceled)

13. (canceled)

14. The activation circuit of claim 1, wherein said zipper slider further comprises a zipper pull.

15. The activation circuit of claim 8, wherein said electrical element is chosen from a light source, an sound emitting device, a vibrating device, and a wireless communication device, optionally said light source is configured to illuminate downwardly, and optionally said sound emitting device is an alarm device.

16. The activation circuit of claim 15, wherein said light source is a light emitting diode (LED) circuit, an incandescent light emitting circuit, or a combination thereof.

17. (canceled)

18. (canceled)

19. The activation circuit of claim 1, wherein said battery is chosen from a small button cell, a rechargeable battery, a solar cell, and combinations thereof, and optionally wherein said battery is mounted to said electrical element.

20. (canceled)

21. (canceled)

22. The activation circuit of claim 8, wherein said electrical element further comprises a securing portion, to secure said electrical element in a fixed position.

23. The activation circuit of claim 1, wherein said zipper slider is configured to activate said activation circuit when in proximity to said magnetic switch or wherein said zipper slider is configured to deactivate said activation circuit when in proximity to said magnetic switch.

24. (canceled)

25. The activation circuit of claim 1, wherein said activation circuit is activated or deactivated when the zipper slider is near the fully open position of said zipper or wherein said activation circuit is activated or deactivated when the zipper slider is near the fully closed position of said zipper.

26. (canceled)

27. A magnetic closure mechanism comprising
a zipper tape having a first and second parallel zipper strip,
a zipper coupled to said zipper tape, said zipper comprising a first and second set of zipper teeth, and
an activation circuit as claimed in claim 1.

28. The magnetic closure mechanism of claim 27, wherein said magnet is configured upon said zipper slider to project said strongest magnetic field along said zipper axis or said magnet is configured upon said zipper slider to project said strongest magnetic field perpendicular to said zipper axis.

29. (canceled)

30. A luggage comprising a magnetic closure mechanism as claimed in claim 27.

31. The luggage of claim 30, wherein said luggage is chosen from a chest, a trunk, a suitcase, a duffel bag, a carpet bag, a handbag, a backpack, and a shoulder bag.

32. (canceled)

33. (canceled)
